(19) United States
(12) Patent Application Publication
(10) Pub. No.: US 2015/0142513 A1
(43) Pub. Date: May 21, 2015

(54) JUST-IN-TIME GUARANTEED ADVERTISEMENT SUPPLY FORECASTING SYSTEM AND METHOD

(71) Applicant: Yahoo! Inc., Sunnyvale, CA (US)

(72) Inventors: Isay Shnayder, San Francisco, CA (US); Konstantin Shmakov, San Jose, CA (US)

(73) Assignee: Yahoo! Inc., Sunnyvale, CA (US)

(21) Appl. No.: 14/084,341

(22) Filed: Nov. 19, 2013

(51) Int. Cl. G06Q 30/02

(52) U.S. Cl. CPC G06Q 30/0206; G06Q 30/0272
USPC 705/7.31

(57) ABSTRACT

A just-in-time advertisement supply forecasting system includes a query engine configured to receive an advertiser query specifying an advertising contract time period of a contract, an historical database having stored therein time series data for a plurality of base profiles, each time series representing previously stored samples corresponding to daily impression counts over a predetermined period of time, and a forecasting engine operatively coupled to the query engine and to the historical database, and configured to generate an impression inventory forecast to satisfy the advertiser query, where the impression inventory forecast is generated in real-time based on the time series, upon receipt of the advertising query.

### TECHNICAL FIELD

The present description relates generally to a system and method for online advertising, and more particularly to a system for forecasting advertisement supply for guaranteed delivery.

### BACKGROUND

In guaranteed display advertising, advertisers can buy contracts that specify a certain number of targeted impressions in the future period of time. For example the contract could be for 10 million impressions of males 25-34 years old, residing in the Bay Area and visiting Sports pages during the period September-December 2013. Internet publishers guarantee these contracts months in advance of the delivery date by relying of supply forecast to identify supply availability with specific targeting for required time period.

The total supply that a publisher can guarantee for a future period of time is limited by the total number of targeted impressions, which in turn is a function of the total number of targeted user visits. A single user visit can result in many impressions. Accurately forecasting the total number of targeted impressions is therefore an important technical problem for publishers in selling guaranteed delivery advertisements.

Supply Forecast (SF) systems are designed to predict future advertisement (ad) opportunities for different properties. Supply forecast queries from advertisers include an arbitrary set of targeting attributes—sites or page identification, ad positions, geography, user attributes, and the like. These queries typically return the following response: 1) prediction of total eligible supply (i.e., sum of eligible impressions) for the contract given the targeting attributes and time interval that the contract specifies, and 2) a forecast of impressions per unit time for the inventory specified by the contract over the specified time interval. For example, an SF query for available inventory for a contract specifying banner ads on the home page for men between the ages of 20-24 in Austin during the month of August, would return a prediction of the total eligible supply of impressions (2 million) and a time series showing the daily number of banner ad impressions projected or forecasted for that demographic over the course of the month (which integrates to 2 million impressions).

The response is generated from historical data of impressions for similar inventory over similar windows of time. A representative historical sample is used by a forecasting engine to generate a response to the query. Improvements to the accuracy of forecasts are important to ensure that both publishers and advertisers receive the most value possible from the guaranteed delivery system.

The problem of forecasting targeted supply is complicated by several factors: 1) For many contracts, historical supply that matches the contract and used for prediction can only be calculated at the time of the advertiser query—a few examples include multi-site and cross-device contracts for which base profiles histories are presented separately for each site and position; 2) Targeting attributes for the contract, for which a forecast is required, will only be known at the query time, and because the potential number of combinations of such attributes can be huge, it is impractical to pre-calculate of all forecasts for all possible combination of attributes; and 3) The duration of the contract and book-ahead time (how long in advance the contract is booked) will be available only at the time of booking, and any forecast made in advance for different durations and book ahead time will not be optimal for the contract.

### SUMMARY

An important insight into the problem of improving forecast accuracy is that the quality of the forecast depends more on the amount of historical data available to feed the forecasting algorithms than it does on the details of the forecasting algorithms themselves. This important insight motivates the invention as disclosed and claimed. In particular, embodiments of the invention disclose improvements on traditional forecasting systems by first aggregating historical time series, which is then adjusted to match the interval of the forecast requested, before producing a forecast. Earlier work on forecasting system overlooked the possibility of this approach because of the difficulty of producing responsive forecasts in real-time.

Another insight motivating the disclosed invention is that a single forecast of a single time series can be done sufficiently fast to provide a response to an advertiser query in real-time. Taken together, these insights and others disclosed in embodiments of the present application lead to the “just in-time” advertisement supply forecasting system and method as disclosed. The aggregation of historical samples can be done in a highly distributed way at query time based on stored historical time series data. In addition, a single forecast can be produced from the aggregated historical samples at query time. The result is a fully online forecasting system—i.e., no offline forecasting and storage of forecasts is required.

A just-in-time advertisement supply forecasting system includes a query engine configured to receive an advertiser query specifying an advertising contract time period of a contract, an historical database having stored therein time series data for a plurality of base profiles, each time series representing previously stored samples corresponding to daily impression counts over a predetermined period of time, and a forecasting engine operatively coupled to the query engine and to the historical database, and configured to generate an impression inventory forecast to satisfy the advertiser query, where the impression inventory forecast is generated in real-time based on the time series, upon receipt of the advertising query.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and method is better understood with reference to the following drawings and description. Non-limiting and non-exhaustive descriptions are described with reference to the following drawings presenting some but not necessarily all embodiments of the invention. In the figures, like referenced numerals is refer to like parts throughout the different figures unless otherwise specified.

FIG. 1 is a block diagram of a network environment where users and/or advertisers interact with a just-in-time advertisement supply forecasting system.

FIG. 2 is a block diagram showing a specific embodiment of a computing infrastructure to which the just-in-time advertisement supply forecasting system of FIG. 1 is operatively coupled.

FIG. 3 is a block diagram of the just-in-time advertisement supply forecasting system of FIG. 2, shown in greater detail.

FIG. 4 is a pictorial representation of a traditional sum of the individual forecasts forecasting system, including the processing results thereof.

FIG. 5 is a flowchart showing processing performed by the just-in-time advertisement supply forecasting system of FIG. 3.

FIG. 6 is a pictorial representation of the just-in-time advertisement supply forecasting system of FIG. 3, including the processing results thereof, according to a first processing block.

FIG. 7 is a pictorial representation of the just-in-time advertisement supply forecasting system of FIG. 3, including the processing results thereof, according to a second processing block.

FIG. 8 is a graph showing the variation of the ratio, r, over time.

FIG. 9 is a pictorial representation of the just-in-time advertisement supply forecasting system of FIG. 3, including the processing results thereof, according to a third processing block.

FIG. 10 is a plot of the variation of the targeting ratio captured by an extended targeting adjustments model.

FIG. 11 shows experimental results of video prediction traffic in accordance with the traditional sum of the individual forecasts forecasting system.

FIG. 12 shows experimental results of video prediction traffic in accordance with the just-in-time advertising supply forecasting system.

FIGS. 13-16 shown experimental prediction results in accordance with the just-in-time advertising supply forecasting system.

### DETAILED DESCRIPTION

Subject matter will now be described more fully hereinafter with reference to the accompanying drawings, which form a part hereof, and which show, by way of illustration, specific example embodiments. Subject matter is, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter is embodied as methods, devices, components, or systems. Accordingly, embodiments is, for example, take the form of hardware, software, firmware or any combination thereof (other than software per se). The following detailed description is, therefore, not intended to be taken in a limiting sense.

Throughout the specification and claims, terms is have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. Accordingly, the invention is not to be restricted except in light of the attached claims and their equivalents.

In general, terminology is understood at least in part from usage in context. For example, terms, such as “and”, “or”, or “and/or,” as used herein is include a variety of meanings that is depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, is used to describe any feature, structure, or characteristic in a singular sense or is used to describe combinations of features, structures or characteristics in a plural sense. Similarly, terms, such as “a,” “an,” or “the,” again, is understood to convey a singular usage or to convey a plural usage, depending at least in part upon context. In addition, the term “based on” is understood as not necessarily intended to convey an exclusive set of factors and is, instead, allow for existence of additional factors not necessarily expressly described, again, depending at least in part on context.

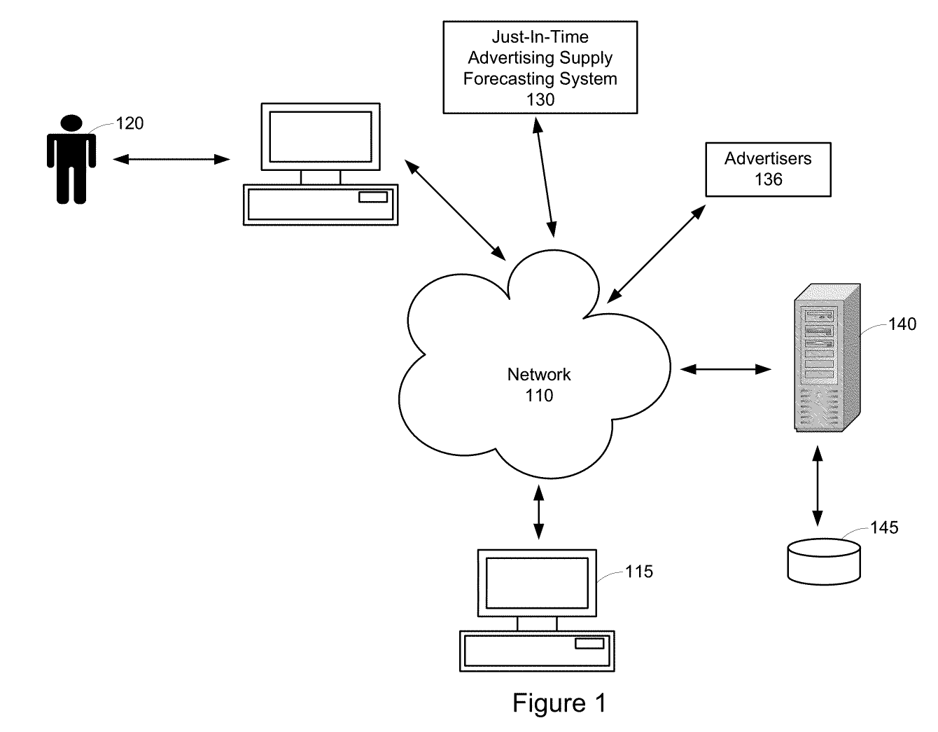

FIG. 1 is a schematic diagram illustrating an example embodiment of a simplified network environment 100. Other embodiments that is vary, for example, in terms of arrangement or in terms of type of components, are also intended to be included within claimed subject matter. The network environment 100 includes, for example, a variety of communication networks 110, such as the Internet, a local area local area network (LAN), wide area network (WAN), a wireless network, and the like.

The network environment 100 includes one or more content providers 115. Content providers 115 generate, create, provide, and/or sponsor content, such as web pages, websites, information, data, or other electronic content to one or more users 120, some of whom may access the network 110 using mobile devices, such as smart phones, tables, PDA's (personal digital assistants), or other wireless device. Examples of content may include text, images, audio, video, or the like, which is processed in the form of physical signals, such as electrical signals, for example, or may stored in memory, as physical states, for example.

A “just-in-time” advertisement supply forecasting system 130 for providing advertisement supply forecasts is operatively coupled to the network 110. One or more advertisers, advertisers, or advertiser brokers 136 may be further coupled to the network 110 and may request advertising forecasts from the just-in-time advertisement forecasting system 130. The advertisers 136 in the form of one or more of the users 120 coupled to the network 110 interact with the just-in-time advertisement supply forecasting system 130. The users 120 and/or the advertisers 136 may be advertising entities, individuals, businesses, machines, or entities that connect and interact with each other and with the just-in-time advertisement supply forecasting system 130. Not all of the depicted components in FIG. 1 are necessarily included in every system, and some implementations may include additional components not shown in the figures. Variations in the arrangement and type of the components may be made without departing from the spirit or scope of the claims as set forth herein.

Note that in FIG. 1, the content provides includes, and may be operable to use or access a content server 140 or search server, which may be indirectly coupled to the content provider 115 through the network 110, or may be directly coupled to the content provided 115. The content server 140 includes a device that provides content via a network to another device. The content server 140, for example, may be a host site, such as a social networking site, examples of which may include, without limitation, Flicker, Twitter, Facebook, LinkedIn, or a personal user site (such as a blog, vlog, online dating site, etc.). The content server 140 may alternatively host a variety of other sites, including, but not limited to business sites, educational sites, dictionary sites, encyclopedia sites, wikis, financial sites, government sites, etc. The content server 140 may be operatively coupled to the storage device or database 145, which may be, or may include distributed storage devices.

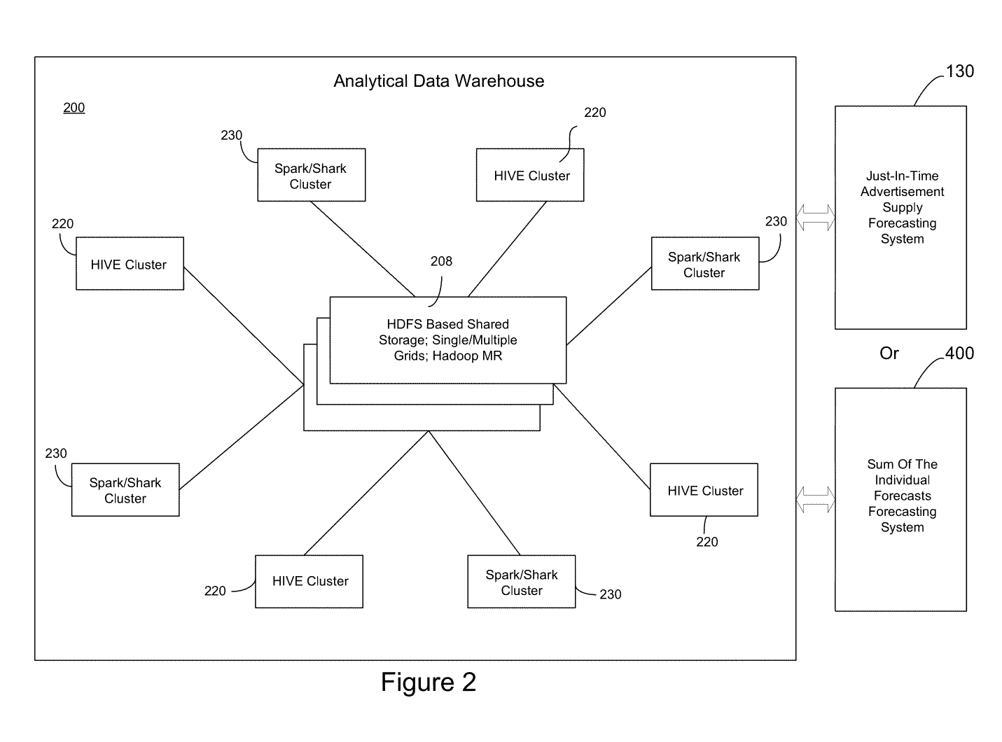

FIG. 2 is a block diagram showing various infrastructure components according to one embodiment, to which the just-in-time advertisement supply forecasting system 130 is operatively coupled. The infrastructure components, in aggregation, are referred to as an analytical data warehouse (ADW) 200. The ADW 200 is built using the Hadoop File System (RDFS) 208 for distributed data storage and the Hadoop Map Reduce (MR) processing system. Distributed storage and processing systems, such as HDFS and Hadoop MR with other components, are sometimes referred to as “grids.” The grid on which the ADW is implemented further includes a Hive system 220 and a Spark/Shark satellite cluster 230 for large-scale computation (cluster computing system).

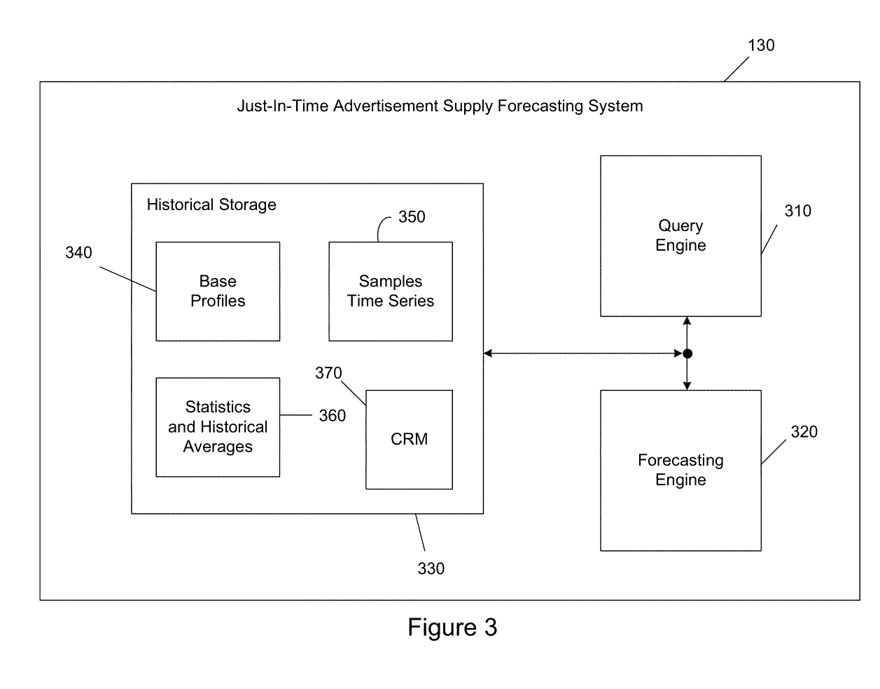

Referring now to FIG. 3, the just-in-time advertisement supply forecasting system 130 includes a query engine 310 for processing a received advertiser query, also referred to as an inventory specification (ISPEC). The query engine 310 is operatively coupled to a forecasting engine 320, which generates the forecast output. The query engine 310 and the forecasting engine 320 are in turn, operatively coupled to an historical data storage system 330 or database (or distributed database systems), which includes base profile data 340, sample and time series data 350, statistical data and historical averages 360 corresponding to the time series data, and in some embodiments, a customer relations management database 370 (CRM database), which stores data regarding various users or those who have browsed certain web pages.

In some embodiments, the time series data 350 may contain data spanning 1,500 days, for example. However, other suitable lengths of time may be used. The base profile data 340, in certain embodiments, is defined by a web page identifier (ID) and a location of an advertisement on that web page. When two such identifiers form the base profile, the base profile is often referred to as a base pair. Thus, depending on the number of advertisements and position of the advertisements on a particular web page, many base pairs may be associated with a single web page. Further, in other embodiments, the base profile may include more than two elemental units of information.

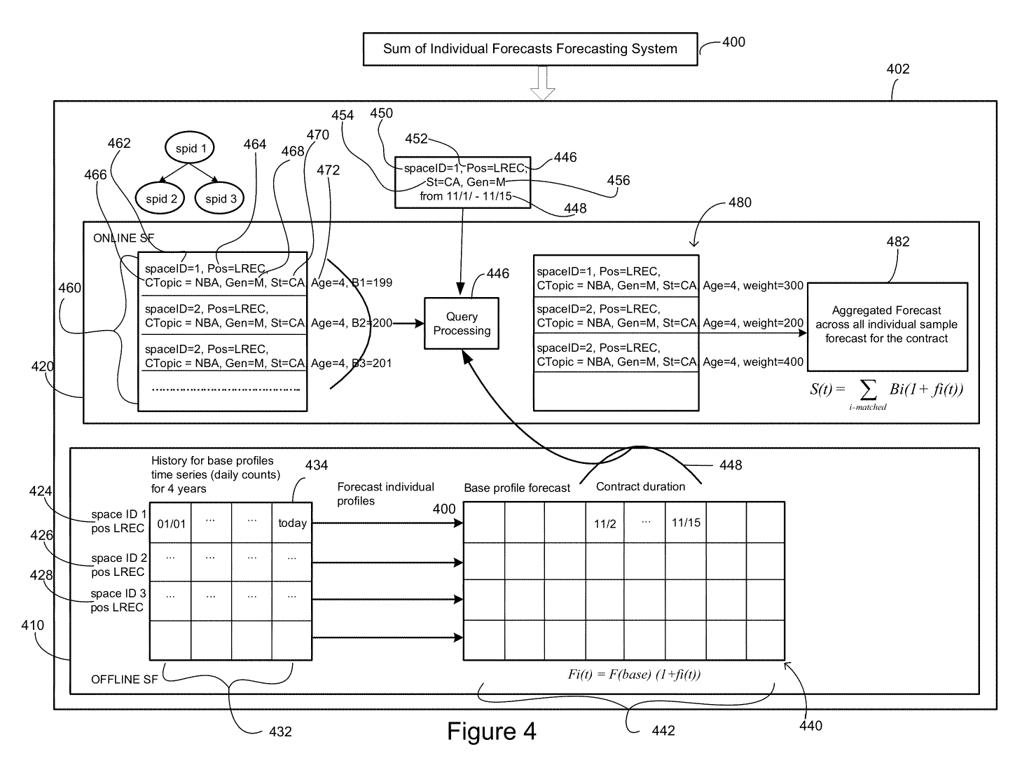

Before describing the just-in-time advertisement supply forecasting system 130 in greater detail, it may be illuminating to first describe a traditional forecasting system below. Referring now to FIG. 4, a traditional forecasting system will now be described, which system is referred to as a “sum of the individual forecasts” forecasting system 400 because the final result is essentially an aggregation of a plurality of individual forecasts. The processing or computational results of the traditional sum of the individual forecasts forecasting system 400 are shown pictorially and labeled as 402. Note that the sum of the individual forecasts forecasting system 400 may utilize the analytical data warehouse 200 or similar computing components shown in FIG. 2 to implement processing, data storage, and database management.

The traditional sum of the individual forecasts forecasting system 400 predicts future supply for every elementary base profile in the system with daily granularity (lowest common denominator), ignoring that contracts typically target more than a single base profile, without regard for actual contract duration, and not taking into account that each contract requires different models, which must be trained based on contract's duration, specific days and book-ahead time.

As shown in processing block 402 of the traditional sum of the individual forecasts forecasting system 400, forecast processing is performed off-line and produces elementary base profile future trends for each base profile in the system. Response to a forecast query for a specific demand (placement, package etc.) for a given time interval is produced as an aggregate of pre-computed elementary base profile trends, with correction for sampling rate. Thus, the forecast is pre-computed in an off-line manner.

An impression sample set contains the number of impressions (weights) at some day in the future. To make this prediction for a future date or time interval, samples are matched to corresponding trends for the nearest parent with valid trends to make future predictions. The sum of these samples with corresponding trends should be equal to the total supply available for the contract. Note that forecasting of total supply and forecasting of samples should be consistent, otherwise booking and optimization would be dealing with different supply numbers.

In FIG. 4, off-line processing 410 and on-line processing 420 are shown with their corresponding interaction and generated output. Trend forecasting is performed off-line, labeled as OFFLINE SF (supply forecast), for individual granular time series (base profiles) with daily granularity. Trends are aggregated online with correction for sampling rate, and daily forecasts are summed to obtain the forecast for the contract.

The traditional sum of the individual forecasts forecasting system 400 predicts total supply by combining multiple predictions made for individual samples, namely for contracts with specific targeting, such as geographical information, user attributes, and the like. Forecasting relies on samples from the previous week of web logs, and links each of these samples to one of the base profile forecasts (called individual trends). However, processing using the traditional sum of the individual forecasts forecasting system 400 results in accumulating errors from individual predictions and overly inaccurate total forecast, especially when individual errors are high and the number of samples is large (˜1000).

The traditional sum of the individual forecasts forecasting system 400 does not make specific predictions for targeted contracts. The forecast for the targeted contract is calculated from forecasts of the untargeted contract scaled by the constant factor, independent on the future time and duration of the contract, where the fraction of samples with specific targeting in the total pool of samples collected for the previous week is projected to be constant in the future. Moreover each sample's scaling factor (or weight) is computed based on number of samples selected for that particular base profile, and the base value is computed based on smooth traffic for that profile. This results in additional forecast errors because representation of a specific targeting group can vary over time. For example, gender and age of an audience on a specific video page can fluctuate based on the content of the videos and specific events, e.g., during the broadcasting of the Olympics.

As an example, a forecasting system may produce forecasts for hundreds of thousands of guaranteed delivery advertising contracts per year. As implied by FIG. 4, this relies on hundreds of thousands of trend forecasts for individual base profiles produced every few days. However, traffic on many video, sports, mobile and other sites, such as on Yahoo! websites, is highly volatile. As a result, of the traditional sum of the individual forecasts forecasting system 400 fails to make accurate predictions.

Predictions are also be unstable when changing from one forecast to another. Inaccuracy and instability in the traditional sum of the individual forecasts forecasting system 400 is illustrated in the following table, for example, based on a one month contract at Yahoo! Sports NFL team site:

TABLE 1

| | Jan. 03, | Jan. 20, | Jan. 30, | Feb. 10, |
|---|---|---|---|---|
| Date | 2013 | 2013 | 2013 | 2013 |
| Forecast | 11005259 | 8742180 | 5953200 | 3399312 |
| Actual | 2598408 | 2598408 | 2598408 | 2598408 |
| Error | +324% | +236% | +129% | +30.8% |

Table 1 above shows predictions made at different times for 1 month Yahoo Sports NFL Team Contract that begins on Feb. 10, 2013. Based on above table, both prediction accuracy and stability are of the order of 100%, and even the forecast made on the first day of the contract for the month was only 30.8% accurate.

In FIG. 4, off-line processing 410 shows three specific time series, namely three rows of time series corresponding to a space ID #1 (424), a space ID #2 (426), and a space ID #3 (428). Each row or time series corresponds to a particular base profile, meaning a page ID and location of an advertisement on that page. Although only three time series or rows are shown, many millions or more of such time series are stored. Each column 432 of each time series corresponds to a sequential list of days, ending in the most recent day, which is labeled as “today” 434. The number of columns, for example, represents 1,500 days of history for each time series, however, any suitable number columns may be recorded.

As shown in a forecasting grid 440, forecasts of future counts, meaning number of impressions corresponding to that base pair, are shown for a plurality of days in the future, as indicated by the eight columns 442 in the forecasting grid 440. The forecast for each day in the future, based on past traffic, extends outwardly sufficiently far in the future to encompass an expected advertiser query 446 for such a future date or duration in the future. In this example of the traditional sum of the individual forecasts forecasting system 400, the contract duration 448 of interest is 14 days (from November 2 to November 15). The future forecast for each box based on the prior information contained in the corresponding time series is calculated using any known suitable technique, such as autocorrelation, seasonal trends, holiday/special real-world event analysis, weekend/monthly/yearly trend analysis, curve fitting, and the like.

Note that when an advertiser query or “inventory specification” is received, query processing 446 processes the query on-line because the advertiser query has just been received. However, such processing of the received advertiser query is based on forecasts that have been pre-calculated offline and saved, and thus are often fairly “stale.” The advertiser query, in this specific example, specifies a contract duration of 14 days (448), with space id=1 (450) and an advertisement position 452 in the page located at LREC (long rectangular). This specified data (page id, page location) represents the base pair for the time series. Also included in the advertiser query is specific user targeting profile information. In this case, the advertiser is interested in users from California 454 (STate=CA), and male users 456 (GENder=M).

Query processing 446 obtains further information from the weblogs or other databases, for each specified time series, as shown in three rows 456, which match the advertiser query. Possible matching information obtained from related databases, includes space id=1 (462), ad position=LREC (464), topic corresponding to the page=NBA (466), gender=Male (468), state=California (470), age group=4 (472), and other information not necessarily shown or described.

Query processing 446 then obtains all of the series which corresponds to the parameters 480 specified by the advertiser query. Since the forecasts for any particular day or days of interest have been previously calculated offline, those forecasts that fall within the specified contract duration for the days in the future, are added and averaged, or weighted, to obtain an aggregated sum of individual forecasts 482, which is then provided to the advertiser as the response to the advertiser query. The above describes the traditional sum of the individual forecasts forecasting system 400.

Returning to the just-in-time advertisement supply forecasting system 130, it is noted that the just-in-time advertisement forecasting system 130 is very different than the traditional sum of the individual forecasts forecasting system 400 of FIG. 4 in that the individual forecast for the days of a particular time series are not pre-calculated nor generated off-line. Rather, each forecast generated by the just-in-time advertisement supply forecasting system 130 is made in real-time and is based on the query parameters (inventory specification or advertiser query) supplied by the advertiser in the advertiser query. Thus, the advertiser receives an answer to its query in real time, with all forecasting generated in real-time at query time.

Note that the just-in-time advertisement supply forecasting system 130 for the contract-specified base profile, based on single time series of aggregated histories of relevant supply pools (samples) with respect to contract duration, is more accurate and more stable than the traditional sum of the individual forecasts forecasting system 400. This is because it is based on aggregated statistics rather than aggregated forecasts. The traditional sum of the individual forecasts forecasting system 400 of FIG. 4, for all samples with corresponding trends, is less accurate on average than the just-in-time advertisement supply forecasting system 130.

In that regard, individual nodes have fewer available statistics and could be subject to larger variations, which contribute to inaccuracy in forecasts using the traditional sum of the individual forecasts forecasting system 400. In contrast, fulfillment of an advertiser query using the just-in-time advertisement supply forecasting system 130 can only be done only at the time of query processing, and in real time.

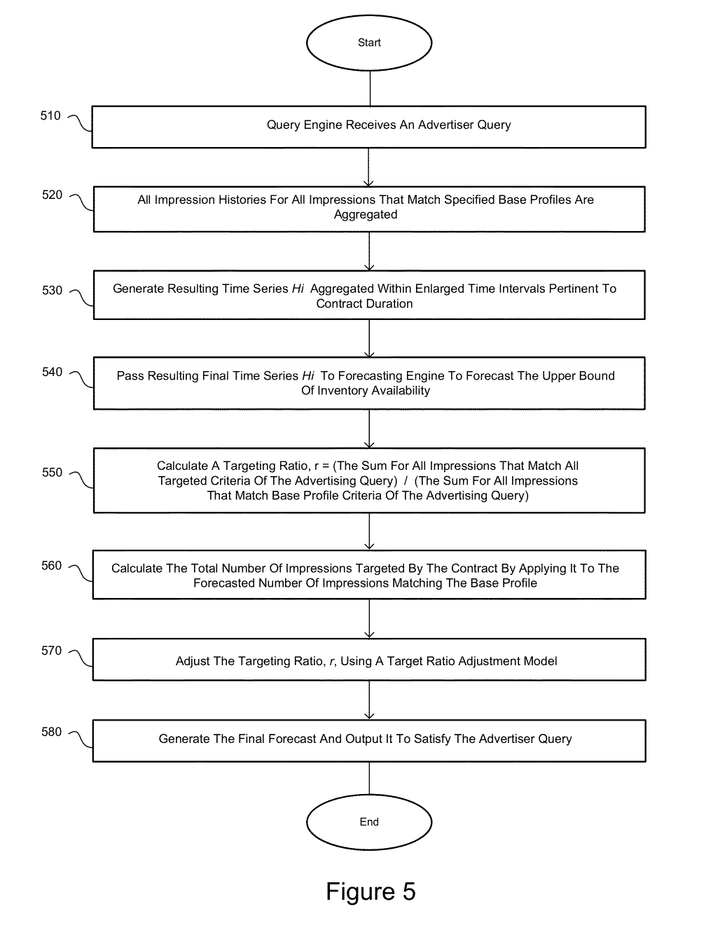

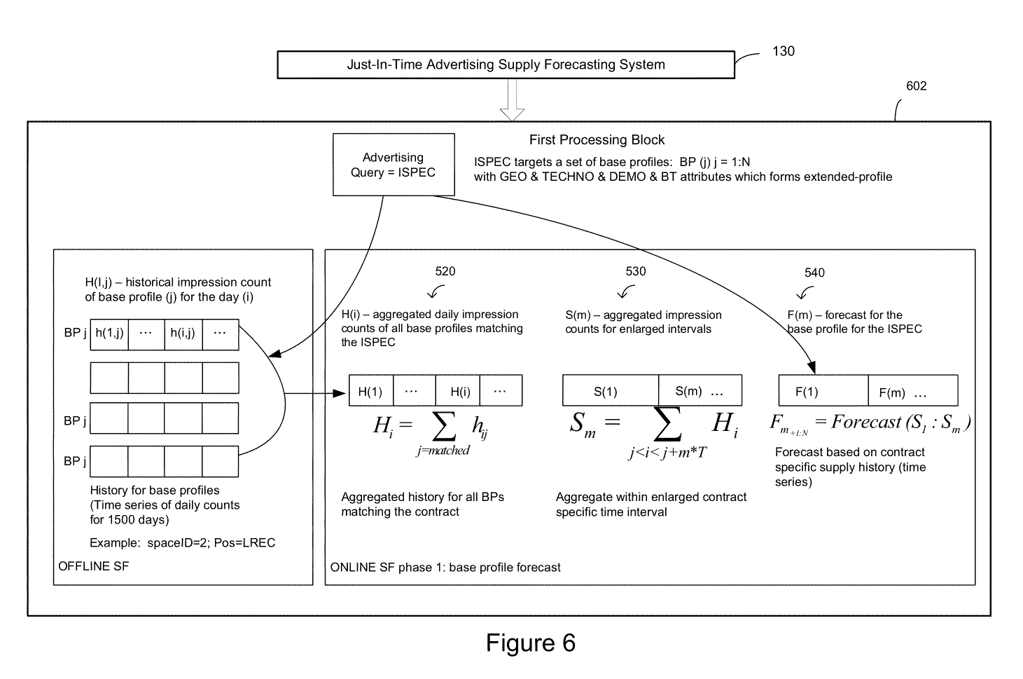

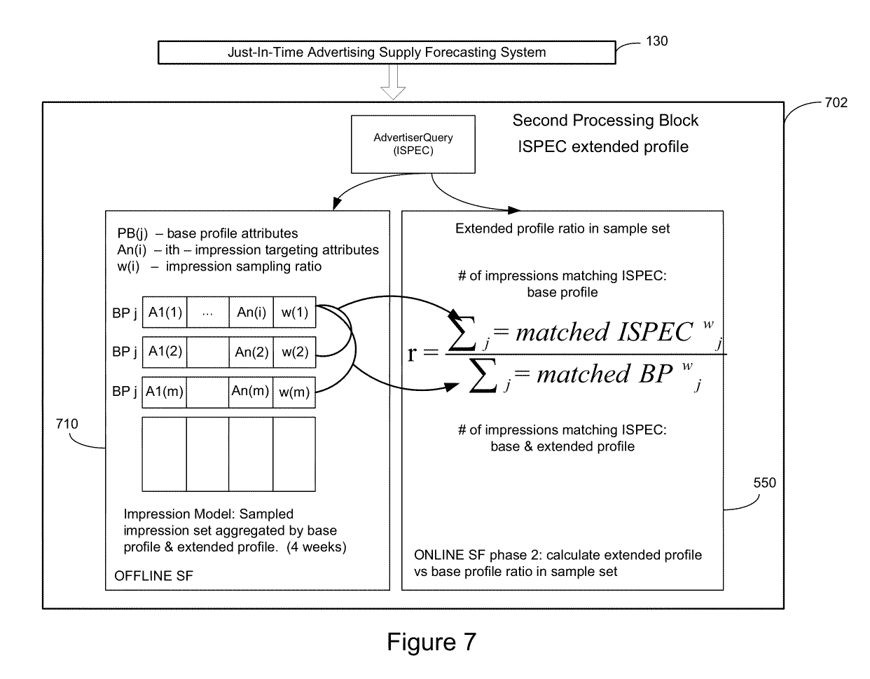

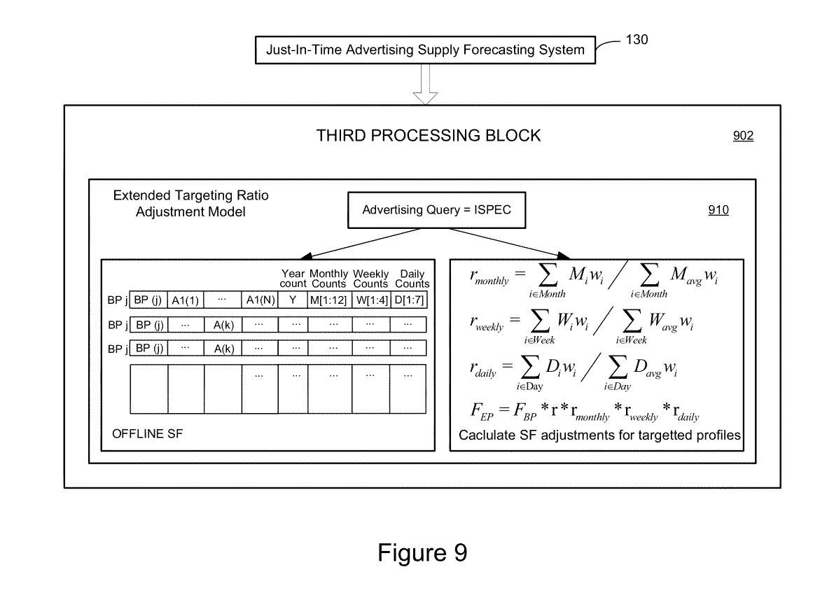

Referring now to FIGS. 5-7 and 9, FIG. 5 is a flowchart showing processing performed by the just-in-time advertisement supply forecasting system 130. FIG. 6 shows in pictorial format a first processing block 602 (FIG. 6) performed by the just-in-time advertisement supply forecasting system 130, which is further described in the flowchart of FIG. 5. FIG. 7 shows in pictorial format a second processing block 702 performed by the just-in-time advertisement supply forecasting system 130, which is further described in the flowchart of FIG. 5. Similarly, FIG. 9 shows in pictorial format a third processing block 902 performed by the just-in-time advertisement supply forecasting system 130, which is further described in the flowchart of FIG. 5.

With respect to FIGS. 5 and 6 generally, the just-in-time advertisement supply forecasting system 130 forecasts the total supply of impressions for the base profile only, ignoring targeting, within contract duration dates. As a first step, the query engine 310 receives an advertiser query (FIG. 5, step 510). Once the advertising query is received, first processing block 602 illustrates that all impression histories for all impressions that match specified base profiles are aggregated (FIG. 5, step 520), as specified in the formula: Hᵢ=Σ_{j=matched}hᵢⱼ where hᵢⱼ is number of impressions delivered for the sample j on the day i, in the past. In one embodiment, historical data is available for 1,500 days for each base profile. However, any suitable time frame may be used depending on storage and computational requirements.

Next, the resulting time series H, is aggregated within enlarged time intervals pertinent to contract duration: Sᵢ=Σ_{j<i<j+m*T}Hᵢ (FIG. 5, step 530). The final time series is used by the forecasting engine 320 (S₁, S₂, . . . , Sᵢ, . . . S₁₅₀₀) to forecast the upper bound of inventory availability (FIG. 5, step 540). The first processing block 602 illustrates that the just-in-time advertising supply forecasting system 130 aggregates histories for all impressions that match the contract and enlarged time intervals.

In accordance with the second processing block 702 in conjunction with FIGS. 5 and 7, the just-in-time advertisement supply forecasting system 130 calculates a ratio r (FIG. 5, step 550) of the sum for all impressions that match all targeted criteria of the advertising query over the sum for all impressions that match the base profile criteria of the advertising query for all samples in the latest weekly set of samples that match the corresponding base profiles. The ratio, r, is calculated using the below formula, across all matched impressions, where “ISPEC” in the below formula is the advertising query shown pictorially in the second processing block 702:

$$r = \frac{\{ {\sum }_{\{ j = matched ISPEC \}} {w}_{j} \}}{\{ {\sum }_{\{ j = matched BP \}} {w}_{j} \}}$$

The ratio, r, calculated for the current week, is used to calculate the total number of impressions targeted by the contract by applying it to the forecasted number of impressions matching the base profile (FIG. 5, step 570). This step is further illustrated in the second processing block 702, which shows the calculation of the targeting ratio, r, from the historical pool of samples 710.

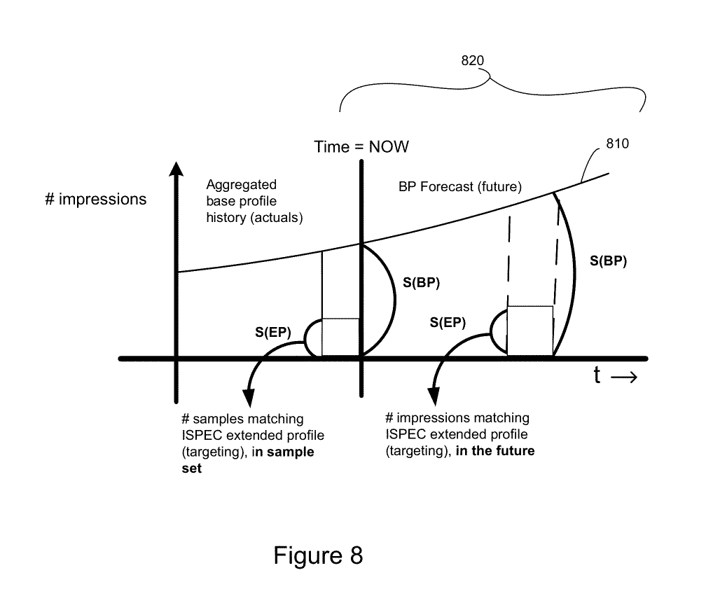

With respect to FIG. 8, the targeting ratio r, however, is not necessarily constant as it is in the traditional sum of the individual forecasts forecasting system 400 of FIG. 4, because the ratio varies over time. Such variation in the targeting ratio r (810) is shown in the graph of FIG. 8. FIG. 8 shows the variation of the targeting ratio, r, for a future period of time (820), with the number of impressions shown on the Y-axis and the time shown on the X-axis.

With respect to FIGS. 5 and 9, the just-in-time advertisement supply forecasting system 130 adjusts the targeting ratio, r, using a target ratio adjustment model (FIG. 5, step 570). Processing according to this model is shown pictorially in FIG. 9 and is labeled as 902. After the targeting ratio, r, has been adjusted, the final forecast is generated and is output (FIG. 5, step 580) in response to the advertiser query. The just-in-time advertisement supply forecasting system 130 adjusts the calculated base profile forecast by scaling it, for example by multiplying it, using the extended targeted ratio adjustment model. Such targeting ratio multiplication is the adjustment performed by the target ratio adjustment model.

With respect to FIG. 9, one such target ratio adjustment model of step 570 is the extended targeting adjustments model described below, shown as block 910 in FIG. 9. The extended targeting adjustment model is a combination of daily, weekly, monthly, and yearly seasonality models built for the counts ratio to average counts ratio (targeting ratio) for specified periods, and signifies the adjustment required to the base profile to account for contract targeting. The extended target ratio adjustment model refines the outcome of the base profile forecast made at the base profile level to account for detailed targeting and seasonality, which is specific to the targeting attributes.

Attributes to form extended profiles are selected based on statistical correlation with user visit counts. Geographical (GEO) and TECHNO targeting attributes are related to user operating environments, such as browser type and version, client operating system, and the like. These attributes are aggregated to some acceptable scale level of hierarchy e.g. techno-targeting attributes form a hierarchy—desktops vs. mobile, mobile consists of feature phones, smart phones, where each type of phone has associated models, and the like. The adjustment ratio is applied at some level of the hierarchy to which all historical samples are aggregated. In this example data will be aggregated to mobile and desktop levels.

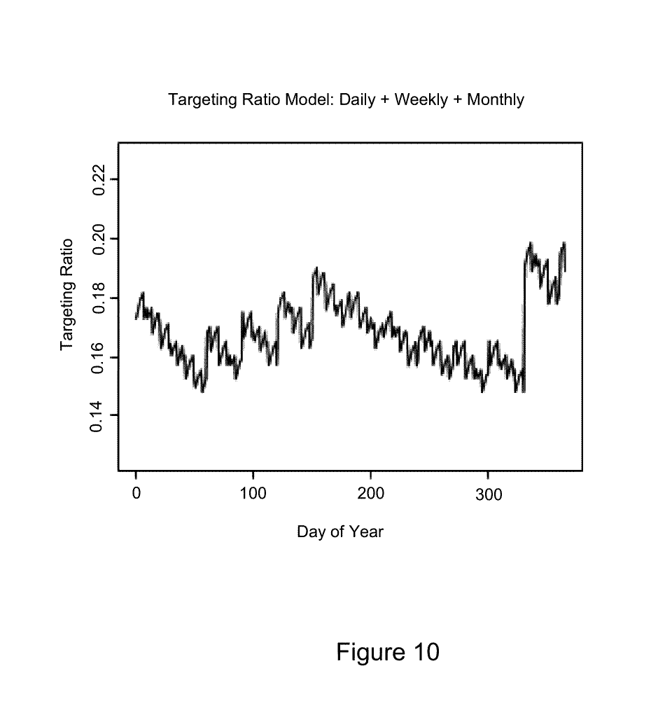

Referring to FIG. 10, the results of the extended targeting adjustment model are shown. FIG. 10 shows that the extended targeting adjustment model captures wide range of variations in the targeting ratio within a year. The results are shown for a single extended base profile. As shown, a wide range of variations in the targeting ratio throughout a year is captured.

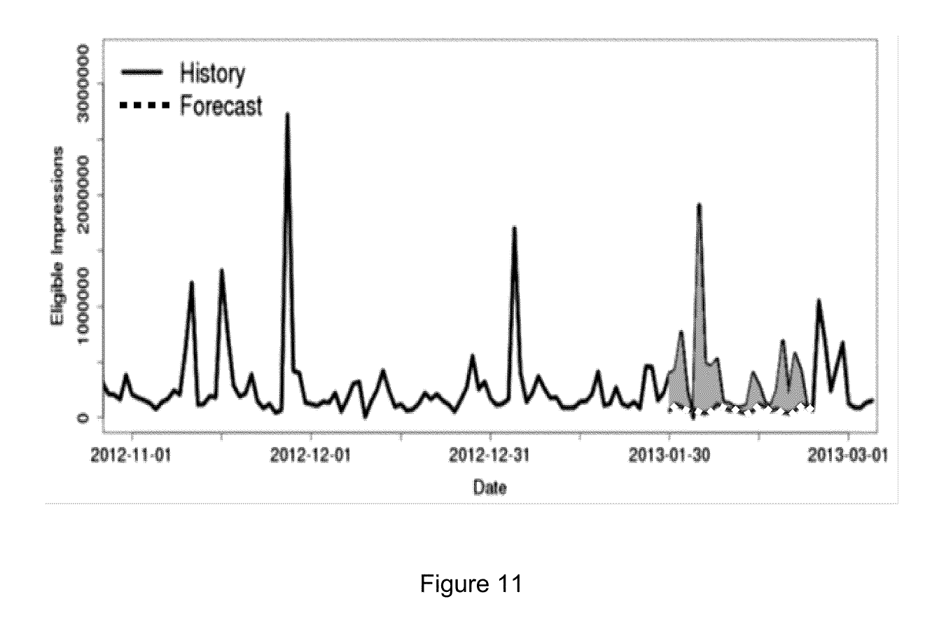

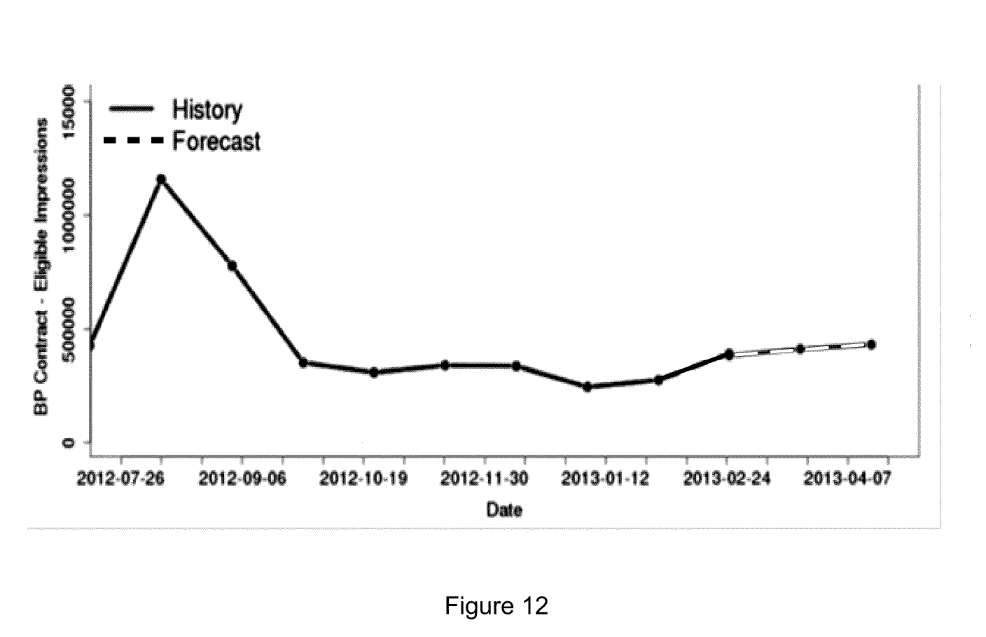

FIG. 11 shows experimental results of video prediction traffic in accordance with the traditional sum of the individual forecasts forecasting system 400, while FIG. 12 shows experimental results of video prediction traffic in accordance with the just-in-time advertisement forecasting system 130. Evaluation of algorithms for purposes of comparison was performed on a set of about 2000 video contracts and sports contracts that historical have exhibited high volatility and for which the traditional sum of the individual forecasts forecasting system 400 was found to produce highly inaccurate forecasts, on the order of about 100% MAPE (mean absolute percentage error).

FIG. 11 shows video traffic prediction for a one month Yahoo! Sports contract according to the traditional sum of the individual forecasts forecasting system 400. As shown, the accuracy of this traditional system 400 is about −79%, while the accuracy of the just-in-time advertisement forecasting system 130 is about 2.1%. As shown in FIG. 12, the just-in-time advertisement forecasting system 130 smoothes the supply with contract duration before making the forecast.

As shown by the contrast from FIG. 11 to FIG. 12, forecast accuracy in this example shows dramatic improvement using the just-in-time advertisement forecasting system 130. On average, for all video contracts, forecasting error improved more than 100% and the stability of forecasts improved more than 200% when using the just-in-time advertisement forecasting system 130. Note that forecast processing of FIG. 5 using the just-in-time advertisement forecasting system 130 operates in real time with historical time series aggregated for the specific contract, and has the benefit of having both the contract and history available.

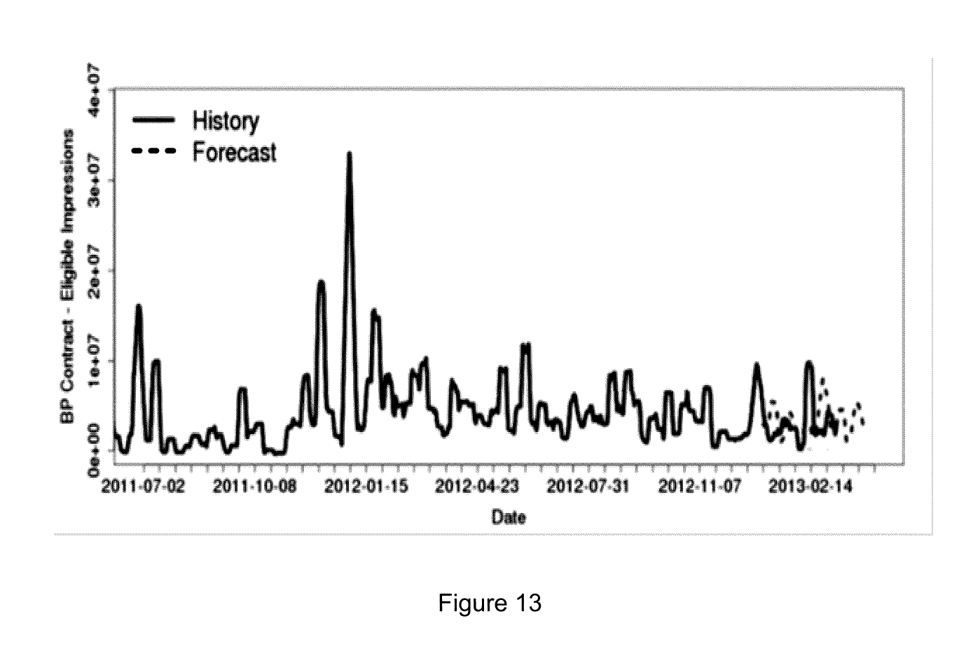

During additional experimental evaluation, the same sports contracts as shown in FIGS. 11 and 12 are used for further evaluation, the results of which are shown in FIGS. 13-16, with four different contract durations. As with video forecasts, in addition to aggregated time series, the just-in-time advertising forecasting system 130 also uses contract duration and book ahead time to arrive at the most accurate prediction.

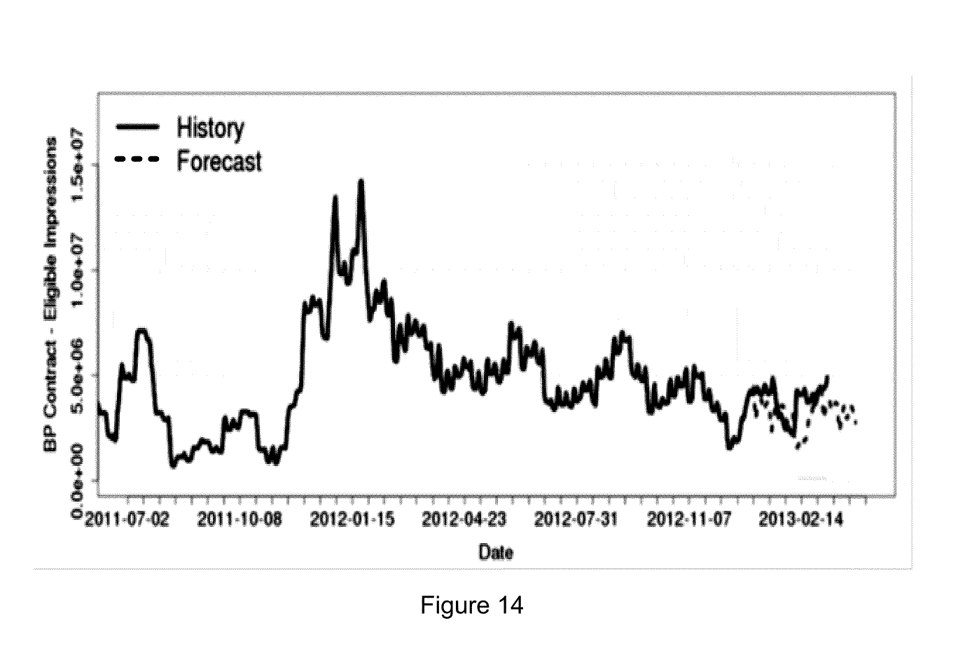

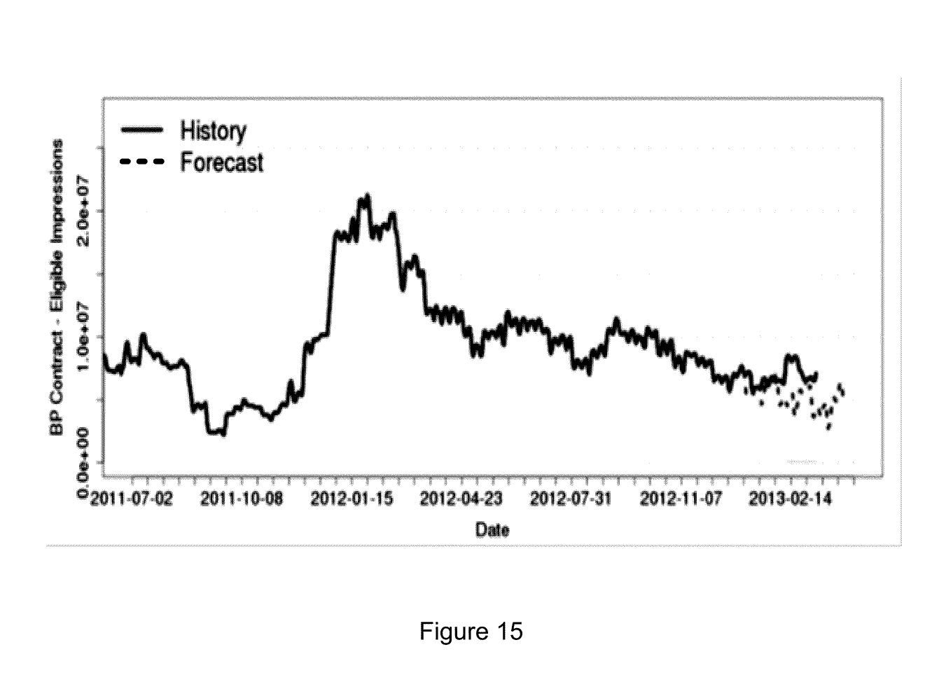

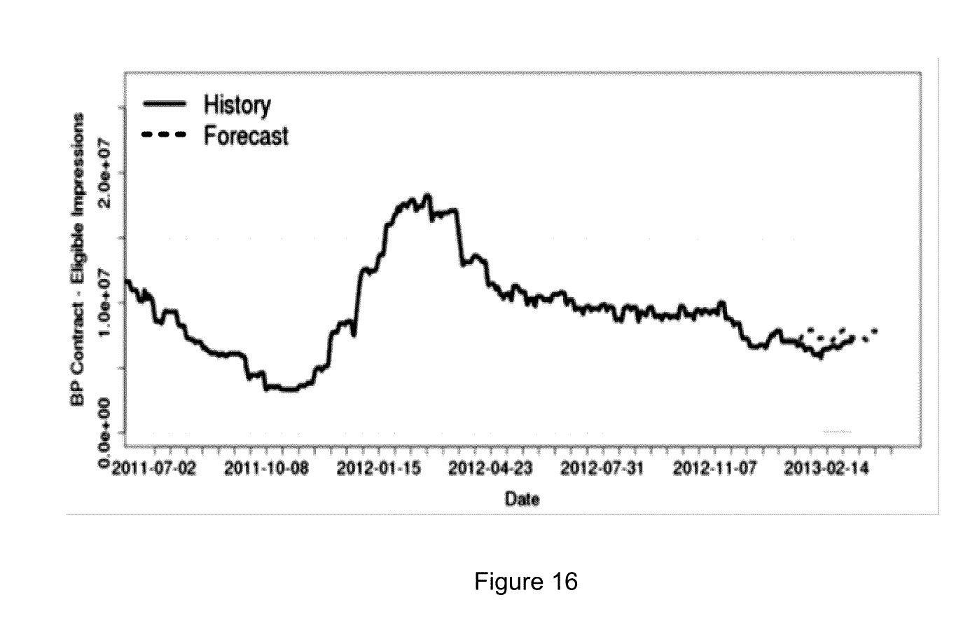

FIG. 13 shows a 7-day contract forecast, which results in an accuracy rate of 49%. FIG. 14 shows a 30-day contract forecast, which results in an accuracy rate of 5.4%. FIG. 15 shows a 60-day contract forecast, which results in an accuracy rate of: 2.4%. FIG. 16 shows a 90 day contract forecast, which results in an accuracy rate of: 2%. Each of the plots in FIGS. 13-16 show time series aggregated within enlarged time intervals. Enlargement within a time interval T is done by calculating a simple moving average over time series with an averaging window T for each duration used for forecasting (shown as a solid line) and corresponding forecast with pacing information (shown as a dashed line) Overall accuracy improves for contracts with longer duration, which have longer aggregation intervals.

Processing in accordance with FIG. 5 of the just-in-time advertisement supply forecasting system 130 also improves stability of the forecast, as forecasts made at different times for the same contract do not show significant variability, as it is the case with processing according to the traditional sum of the individual forecasts forecasting system 400. Results of different just-in-time forecasts for Yahoo Sport NFL team contracts are show in the table below—they are stable within 5-8% which is compared with processing according to the traditional sum of the individual forecasts forecasting system 400, which traditional system exhibits a 100-200% stability for the same profile (see Table 1). Table 2 below shows predictions made at different times for 1 month Yahoo Sports NFL Team Contract that begins Feb. 10, 2013.

TABLE 2

| | Jan. 03, | Jan. 20, | Jan. 30, | Feb. 10, |
|---|---|---|---|---|
| Date | 2013 | 2013 | 2013 | 2013 |
| Actual | 2598408 | 2598408 | 2598408 | 2598408 |
| JIT SF | 2744467 | 2800309 | 2725770 | 2554882 |
| JIT error | +5.6% | +7.8% | +4.9% | −1.7% |

For longer contract durations, forecasting accuracy improves ever more. This information is available at the time of booking (through evaluating the same contract over past periods) and can be used to optimize the contract and provide recommendations. This is illustrated in Table 3 below based on an example of Yahoo! Sports contracts with different durations. Table 3 shows forecasting accuracy for Yahoo Sports Contract with different durations and book-ahead time. For longer contract durations forecasting accuracy improves. This information is available at the time of booking.

TABLE 3

| | | |
|---|---|---|
| Contract Duration | Start Date | Guarantees* |

| | | | |
|---|---|---|---|
| 1 | day | Next week | 98% |
| 7 | days | Next week | 49% |
| 7 | days | Next day | 42% |
| 14 | days | Next day | 22% |
| 1 | Month | Next day | 5.4% |
| 2 | Month | Next day | 2.4% |
| 3 | Month | Next day | 2.0% |

Because the just-in-time forecast is performed on a single time series, the accuracy of the forecast is estimated at the time of query for the specific contract by applying the just-in-time model to the past period for which history is available. Further, booking optimization finds optimal time intervals (flight date and duration) for the contract to succeed, meaning there is a better chance to fulfill the guarantees of impression delivery, with a higher confidence level. Additional, the just-in-time advertisement supply forecasting system 130 returns the pacing information, that is, the monthly/weekly/daily inventory forecasts for the specified time interval, and optimizes contract pacing by allowing for optimized time interval for the contract.

Referring back to FIG. 1, the content server 140 is provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of devices that is operate as a content server include desktop computers, multiprocessor systems, microprocessor-type or programmable consumer electronics. Other examples are possible.

Servers is vary widely in configuration or capabilities, but generally a server is include one or more central processing units and memory. A server is also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The various client devices and/or client applications 120, including the advertisement forecasting system 130, is include or is execute a variety of operating systems, including a personal computer operating system, such as a Windows, iOS or Linux, or a mobile operating system, such as iOS, Android, or Windows Mobile, or the like. Such client devices and or applications is include or is execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The client devices and/or client applications 120 is also include or execute an application to communicate content, such as, for example, textual content, multimedia content, or the like. The client devices and/or client applications 120 is also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

With respect to FIG. 1, the network 110 is also include other mass storage in addition to the storage device or database 145, such as network attached storage (NAS), a storage area network (SAN), or other forms of computer or machine readable media, for example. The network 110 is include the Internet, one or more local area networks (LANs), one or more wide area networks (WANs), wire-line type connections, wireless type connections, or any combination thereof. Likewise, sub-networks, such as is employ differing architectures or is compliant or compatible with differing protocols, is interoperate within a larger network. Various types of devices is, for example, be made available to provide an interoperable capability for differing architectures or protocols. As one illustrative example, a router is provide a link between otherwise separate and independent LANs

The network 110, which is a communication link or channel, is include for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as is known to those skilled in the art. Furthermore, a computing device or other related electronic devices is remotely coupled to a network, such as via a telephone line or link, for example.

The network 110 is include wired or wireless networks. A wireless network is couple client devices with a network. A wireless network is employ stand-alone ad-hoc networks, mesh networks, Wireless LAN (WLAN) networks, cellular networks, an 802.11, 802.16, 802.20, or WiMax network. Further, the network 110 is a public network, such as the Internet, a private network, such as an intranet, or combinations thereof, and is utilize a variety of networking protocols now available or later developed including, but not limited to TCP/IP based networking protocols.

A wireless network is further include a system of terminals, gateways, routers, or the like coupled by wireless radio links, or the like, which is move freely, randomly or organize themselves arbitrarily, such that network topology is change, at times even rapidly. A wireless network is further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies is enable wide area coverage for devices, such as client devices with varying degrees of mobility, for example.

For example, a network is enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network is include virtually any type of wireless communication mechanism by which signals is communicated between devices, such as a client device or a computing device, between or within a network, or the like.

Many communication networks send and receive signal packets communicated via the various networks and sub-networks, and form a participating digital communication network, and which is compatible with or compliant with one or more protocols. Signaling formats or protocols employed is include, for example, TCP/IP, UDP, DECnet, NetBEUI, IPX, Appletalk, or the like. Versions of the Internet Protocol (IP) is include IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets is communicated between nodes of a network, such as, for example, to one or more sites employing a local network address. A signal packet is, for example, be communicated over the Internet from a user site via an access node coupled to the Internet. Likewise, a signal packet is forwarded via network nodes to a target site coupled to the network via a network access node, for example. A signal packet communicated via the Internet is, for example, be routed via a path of gateways, servers, etc. that is route the signal packet in accordance with a target address and availability of a network path to the target address.

The network 110 is or include a content distribution network. A “content delivery network” or “content distribution network” (CDN) generally refers to a distributed content delivery system that comprises a collection of computers or computing devices linked by a network or networks. A CDN is employ software, systems, protocols or techniques to facilitate various services, such as storage, caching, communication of content, or streaming media or applications. Services is also make use of ancillary technologies including, but not limited to, “cloud computing,” distributed storage, DNS request handling, provisioning, signal monitoring and reporting, content targeting, personalization, or business intelligence. A CDN is also enable an entity to operate or manage another's site infrastructure, in whole or in part.

The network 110 is or include a peer-to-peer network. A peer-to-peer (or P2P) network is employ computing power or bandwidth of network participants in contrast with a network that is employ dedicated devices, such as dedicated servers, for example; however, some networks is employ both as well as other approaches. A P2P network is typically be used for coupling nodes via an ad hoc arrangement or configuration. A peer-to-peer network is employ some nodes capable of operating as both a “client” and a “server.”

The network 110 is or include a social network. The term “social network” refers generally to a network of individuals, such as acquaintances, friends, family, colleagues, or co-workers, coupled via a communications network or via a variety of sub-networks. Potentially, additional relationships is subsequently be formed as a result of social interaction via the communications network or sub-networks. A social network is employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network is include individuals with similar experiences, opinions, education levels or backgrounds. Subgroups is exist or be created according to user profiles of individuals, for example, in which a subgroup member belongs to multiple subgroups. An individual is also have multiple “1:few” associations within a social network, such as for family, college classmates, or co-workers.

An individual's social network is refer to a set of direct personal relationships or a set of indirect personal relationships. A direct personal relationship refers to a relationship for an individual in which communications is individual to individual, such as with family members, friends, colleagues, co-workers, or the like. An indirect personal relationship refers to a relationship that is available to an individual with another individual although no form of individual to individual communication is have taken place, such as a friend of a friend, or the like. Different privileges or permissions is associated with relationships in a social network. A social network also is generate relationships or connections with entities other than a person, such as companies, brands, or so-called ‘virtual persons.’ An individual's social network is represented in a variety of forms, such as visually, electronically or functionally. For example, a “social graph” or “socio-gram” is represent an entity in a social network as a node and a relationship as an edge or a link.

In accordance with various embodiments of the present disclosure, the methods described herein is implemented by software programs executable by a computer system. Further, in an example, non-limited embodiment, implementations can include distributed processing, component/object distributed processing, and parallel processing. Alternatively, virtual computer system processing can be constructed to implement one or more of the methods or functionality as described herein.

The network environment 100 is configured or operable for multi-modal communication which is occur between members of a social network. Individuals within one or more social networks is interact or communication with other members of a social network via a variety of devices. Multi-modal communication technologies refers to a set of technologies that permit interoperable communication across multiple devices or platforms, such as cell phones, smart phones, tablet computing devices, personal computers, televisions, SMS/MMS, email, instant messenger clients, forums, social networking sites (such as Facebook, Twitter, or Google+), or the like.

A search engine is enable a device, such as a client device, to search for files of interest using a search query. Typically, a search engine is accessed by a client device via one or more servers. A search engine is, for example, in one illustrative embodiment, comprise a crawler component, an indexer component, an index storage component, a search component, a ranking component, a cache, a profile storage component, a logon component, a profile builder, and one or more application program interfaces (APIs). A search engine is deployed in a distributed manner, such as via a set of distributed servers, for example. Components is duplicated within a network, such as for redundancy or better access.

A crawler is operable to communicate with a variety of content servers, typically via network. In some embodiments, a crawler starts with a list of URLs to visit, which is referred to as a seed list. As the crawler visits the URLs in the seed list, it is identify some or all the hyperlinks in the page and add them to a list of URLs to visit, which is referred to as a crawl frontier. URLs from the crawler frontier is recursively visited according to a set of policies. A crawler typically retrieves files by generating a copy for storage, such as local cache storage. A cache is refer to a persistent storage device. A crawler is likewise follow links, such as HTTP hyperlinks, in the retrieved file to additional files and is retrieve those files by generating copy for storage, and so forth. A crawler is therefore retrieve files from a plurality of content servers as it “crawls” across a network.

An indexer is operable to generate an index of content, including associated contextual content, such as for one or more databases, which is searched to locate content, including contextual content. An index is include index entries, wherein an index entry is assigned a value referred to as a weight. An index entry is include a portion of the database. In some embodiments, an indexer is use an inverted index that stores a mapping from content to its locations in a database file, or in a document or a set of documents. A record level inverted index contains a list of references to documents for each word. A word level inverted index additionally contains the positions of each word within a document. A weight for an index entry is assigned. For example, a weight, in one example embodiment is assigned substantially in accordance with a difference between the number of records indexed without the index entry and the number of records indexed with the index entry.

The term “Boolean search engine” refers to a search engine capable of parsing Boolean-style syntax, such as is used in a search query. A Boolean search engine is allow the use of Boolean operators (such as AND, OR, NOT, or XOR) to specify a logical relationship between search terms. For example, the search query “college OR university” is return results with “college,” results with “university,” or results with both, while the search query “college XOR university” is return results with “college” or results with “university,” but not results with both.

In contrast to Boolean-style syntax, “semantic search” refers a search technique in which search results are evaluated for relevance based at least in part on contextual meaning associated with query search terms. In contrast with Boolean-style syntax to specify a relationship between search terms, a semantic search is attempt to infer a meaning for terms of a natural language search query. Semantic search is therefore employ “semantics” (e.g., science of meaning in language) to search repositories of various types of content.

Search results located during a search of an index performed in response to a search query submission is typically be ranked. An index is include entries with an index entry assigned a value referred to as a weight. A search query is comprise search query terms, wherein a query term is correspond to an index entry. In an embodiment, search results is ranked by scoring located files or records, for example, such as in accordance with number of times a query term occurs weighed in accordance with a weight assigned to an index entry corresponding to the query term. Other aspects is also affect ranking, such as, for example, proximity of query terms within a located record or file, or semantic usage, for example. A score and an identifier for a located record or file, for example, is stored in a respective entry of a ranking list. A list of search results is ranked in accordance with scores, which is, for example, be provided in response to a search query. In some embodiments, machine-learned ranking (MLR) models are used to rank search results. MLR is a type of supervised or semi-supervised machine learning problem with the goal to automatically construct a ranking model from training data.

In one embodiment, as an individual interacts with a software application, e.g., an instant messenger or electronic mail application, descriptive content, such in the form of signals or stored physical states within memory, such as, for example, an email address, instant messenger identifier, phone number, postal address, message content, date, time, etc., is identified. Descriptive content is stored, typically along with contextual content. For example, how a phone number came to be identified (e.g., it was contained in a communication received from another via an instant messenger application) is stored as contextual content associated with the phone number. Contextual content, therefore, is identify circumstances surrounding receipt of a phone number (e.g., date or time the phone number was received) and is associated with descriptive content. Contextual content, is, for example, be used to subsequently search for associated descriptive content. For example, a search for phone numbers received from specific individuals, received via an instant messenger application or at a given date or time, is initiated.

Content within a repository of media or multimedia, for example, is annotated. Examples of content is include text, images, audio, video, or the like, which is processed in the form of physical signals, such as electrical signals, for example, or is stored in memory, as physical states, for example. Content is contained within an object, such as a Web object, Web page, Web site, electronic document, or the like. An item in a collection of content is referred to as an “item of content” or a “content item,” and is retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations is include various fields of descriptive content, such as a rating of a document, a list of keywords identifying topics of a document, etc.

A profile builder is initiate generation of a profile, such for users of an application, including a search engine, for example. A profile builder is initiate generation of a user profile for use, for example, by a user, as well as by an entity that is have provided the application. For example, a profile builder is enhance relevance determinations and thereby assist in indexing, searching or ranking search results. Therefore, a search engine provider is employ a profile builder, for example. A variety of mechanisms is implemented to generate a profile including, but not limited to, collecting or mining navigation history, stored documents, tags, or annotations, to provide a few examples. A profile builder is store a generated profile. Profiles of users of a search engine, for example, is give a search engine provider a mechanism to retrieve annotations, tags, stored pages, navigation history, or the like, which is useful for making relevance determinations of search results, such as with respect to a particular user.

Advertising is include sponsored search advertising, non-sponsored search advertising, guaranteed and non-guaranteed delivery advertising, ad networks/exchanges, ad targeting, ad serving, and/or ad analytics. Various monetization techniques or models is used in connection with sponsored search advertising, including advertising associated with user search queries, or non-sponsored search advertising, including graphical or display advertising. In an auction-type online advertising marketplace, advertisers is bid in connection with placement of advertisements, although other factors is also be included in determining advertisement selection or ranking. Bids is associated with amounts advertisers pay for certain specified occurrences, such as for placed or clicked-on advertisements, for example. Advertiser payment for online advertising is divided between parties including one or more publishers or publisher networks, one or more marketplace facilitators or providers, or potentially among other parties.

Some models is include guaranteed delivery advertising, in which advertisers is pay based at least in part on an agreement guaranteeing or providing some measure of assurance that the advertiser will receive a certain agreed upon amount of suitable advertising, or non-guaranteed delivery advertising, which is include individual serving opportunities or spot market(s), for example. In various models, advertisers is pay based at least in part on any of various metrics associated with advertisement delivery or performance, or associated with measurement or approximation of particular advertiser goal(s). For example, models is include, among other things, payment based at least in part on cost per impression or number of impressions, cost per click or number of clicks, cost per action for some specified action(s), cost per conversion or purchase, or cost based at least in part on some combination of metrics, which is include online or offline metrics, for example.

A process of buying or selling online advertisements is involve a number of different entities, including advertisers, publishers, agencies, networks, or developers. To simplify this process, organization systems called “ad exchanges” is associate advertisers or publishers, such as via a platform to facilitate buying or selling of online advertisement inventory from multiple ad networks. “Ad networks” refers to aggregation of ad space supply from publishers, such as for provision en masse to advertisers.

For web portals like Yahoo!, advertisements is displayed on web pages resulting from a user-defined search based at least in part upon one or more search terms. Advertising is beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements is presented to users in a targeted audience based at least in part upon predicted user behavior(s).

Another approach includes profile-type ad targeting. In this approach, user profiles specific to a user is generated to model user behavior, for example, by tracking a user's path through a web site or network of sites, and compiling a profile based at least in part on pages or advertisements ultimately delivered. A correlation is identified, such as for user purchases, for example. An identified correlation is used to target potential purchasers by targeting content or advertisements to particular users.

An “ad server” comprises a server that stores online advertisements for presentation to users. “Ad serving” refers to methods used to place online advertisements on websites, in applications, or other places where users are more likely to see them, such as during an online session or during computing platform use, for example.

During presentation of advertisements, a presentation system is collect descriptive content about types of advertisements presented to users. A broad range of descriptive content is gathered, including content specific to an advertising presentation system. Advertising analytics gathered is transmitted to locations remote to an advertising presentation system for storage or for further evaluation. Where advertising analytics transmittal is not immediately available, gathered advertising analytics is stored by an advertising presentation system until transmittal of those advertising analytics becomes available.

While the computer-readable medium as described or set forth in the appended claim is described as a single medium, the term “computer-readable medium” is include a single medium or multiple media, such as a centralized or distributed database, and/or associated caches and servers that store one or more sets of instructions. The term “computer-readable medium” is also include any medium that is capable of storing, encoding or carrying a set of instructions for execution by a processor or that cause a computer system to perform any one or more of the methods or operations disclosed herein. The “computer-readable medium” is non-transitory, and is tangible.

Note that dedicated hardware implementations, such as application specific integrated circuits, programmable logic arrays and other hardware devices, can be constructed to implement one or more of the methods described herein. Applications that is include the apparatus and systems of various embodiments can broadly include a variety of electronic and computer systems. One or more embodiments described herein is implement functions using two or more specific interconnected hardware modules or devices with related control and data signals that can be communicated between and through the modules, or as portions of an application-specific integrated circuit. Accordingly, the present system encompasses software, firmware, and hardware implementations.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A just-in-time advertisement supply forecasting system, comprising:
a query engine configured to receive an advertiser query specifying an advertising contract time period of a contract;
an historical database having stored therein time series data for a plurality of base profiles, each time series representing previously stored samples corresponding to daily impression counts over a predetermined period of time;
a forecasting engine operatively coupled to the query engine and to the historical database, and configured to generate an impression inventory forecast to satisfy the advertiser query; and
wherein the impression inventory forecast is generated in real-time based on the time series, upon receipt of the advertising query.

2. The system of claim 1, wherein the advertiser query identifies at least one desired base profile and desired user target attributes.

3. The system of claim 1, wherein the generated impression inventory forecast includes a prediction of a total eligible impression inventory corresponding to the advertising contract and a forecast per unit of time of the impression inventory over the advertising contract period of time.

4. The system of claim 1, wherein the generated impression inventory forecast includes pacing information detailing daily, weekly, and monthly inventory supply predictions over the advertising contract period of time.

5. The system of claim 2, wherein the forecasting engine calculates a total supply of impressions corresponding to the desired base profile by aggregating the time series data for the desired base profile within an enlarged time interval based on the advertising contract time period, to generate a resultant time series, Hᵢ.

6. The system of claim 2, wherein the forecasting engine calculates a targeting ratio, r, of the sum of all targeted base profile impressions calculated for a current week of the time series.

7. The system of claim 6, wherein the forecasting engine calculates a total number of impressions corresponding to the advertiser query by multiplying the targeting ratio, r, by the resultant time series, Hᵢ.

8. The system of claim 6, wherein the forecasting engine adjusts the calculated targeting ratio, r, by scaling impression inventory forecast using an extended target ratio adjustment model

9. The system of claim 8, wherein the extended target ratio adjustment model includes a combination of daily, weekly and monthly seasonality models based on predetermined time periods, and represents an adjustment to account for the desired user target attributes specified by the advertiser query.

10. A just-in-time advertising supply forecasting method, comprising:
receiving in real-time, an advertiser query specifying an advertising contract time period and at least one desired base profile;
identifying one or more of time series corresponding to the desired base profile;
aggregating the time series data for the desired base profile within an enlarged time interval based on the advertising contract time period, to generate a resultant time series, Hᵢ;
calculating a targeting ratio, r, of the sum of all targeted base profile impressions calculated for a current week of the time series;
calculating a total number of impressions corresponding to the advertiser query by multiplying the targeting ratio, r, by the resultant time series, Hᵢ.
adjusting the total number of calculated impressions by applying a targeting adjustment ratio model to generate an adjusted impression inventory forecast; and
providing the adjusted impression inventory forecast to satisfy the advertiser query.

11. The method of claim 10, comprising:
recording, during off-line processing, daily traffic for a plurality of base profiles to generate a time series for each base profile, the time series representing daily impression counts over a predetermined period of time;

12. The method of claim 10, wherein the adjusted impression inventory forecast includes a prediction of a total eligible impression inventory corresponding to the advertising contract and a forecast per unit of time of the impression inventory over the advertising contract period of time.

13. The method of claim 10, wherein the target ratio adjustment model is an extended target ratio adjustment model, and includes a combination of daily, weekly and monthly seasonality models based on predetermined time periods, and represents an adjustment to account for the desired user target attributes specified by the advertiser query.

14. The method of claim 10, wherein the each base profile includes at least a page identifier (id) and an advertisement placement location of the corresponding page.

15. The method of claim 10, wherein the time series includes traffic data for about 1500 days.

16. The method of claim 10, wherein the adjusted impression inventory forecast is generated in real-time and is only generated after the advertiser query is received.

17. The method of claim 11, wherein off-line processing generates and stores the time series for each base profile, and provides no forecast generation associated with the time series.

18. The method of claim 10, wherein the number of base profiles is between 10 million and 250 million.

19. The method according to claim 10 wherein application of the targeting adjustment ratio model adjusts the impression inventory forecast to account for the desired user target attributes specified by the advertiser query.

20. A just-in-time advertising supply forecasting method, comprising:
recording, during off-line processing, daily traffic for a plurality of base profiles to generate a time series for each base profile, the time series representing an aggregation of samples corresponding to daily impression counts over a predetermined period of time;
in real-time:
receiving an advertiser query specifying an advertising contract time period and an advertising profile of interest, the advertising profile of interest specifying at least one desired base profile and desired user target attributes;
identifying one or more of time series corresponding to the identified desired base profiles;
aggregating the time series data for the desired base profile within an enlarged time interval based on the advertising contract time period, to generate a resultant time series, Hᵢ;
calculating a targeting ratio, r, of the sum of all targeted base profile impressions calculated for a current week of the time series;
calculating a total number of impressions corresponding to the advertiser query by multiplying the targeting ratio, r, by the resultant time series, Hᵢ.
adjusting the total number of calculated impressions by applying a targeting adjustment ratio model to generate an adjusted impression inventory forecast; and
providing the adjusted impression inventory forecast to satisfy the advertisement query.
